(19) United States
(12) Patent Application Publication
(10) Pub. No.: US 2007/0260401 A1
(43) Pub. Date: Nov. 8, 2007

(54) METHOD AND SYSTEM FOR ASSESSMENT AND DETERMINING ENVIRONMENTAL RISK FOR PARCELS

(76) Inventors: Michael W. Sydor, Bainbridge Island, WA (US); Paul E. Hausmann, Bainbridge Island, WA (US)

Correspondence Address: LAW OFFICE OF R. ALAN BURNETT, 4108 131ST AVE. SE, BELLEVUE, WA, 98006, US

(21) Appl. No.: 11/744,306

(22) Filed: May 4, 2007

Related U.S. Application Data
(60) Provisional application No. 60/746,413, filed on May 4, 2006.

(51) Int. Cl. G06F 19/00; G06F 17/30; G06F 17/40

(52) U.S. Cl. 702/1; 707/1; 707/10; 707/104.1; 702/127; 702/189

(57) ABSTRACT

A method and system for automating the assessment and determination of environmental risks for properties and regions. Property attribute and characteristic data is aggregated from multiple databases and indexed by a parcel identifier, such as an assessor's parcel number (APN). Environmental data from various databases, such as Federal, State, County, Parrish, Municipality/Town, Tribal, etc. is also retrieved and linked to parcels. An environmental risk assessment score may be calculated based on various attribute, characteristic, and environmental data associated with a given parcel, a parcel and adjacent properties, and/or selected areas or regions. Environmental risk assessment maps may also be generated.

### RELATED APPLICATIONS

This application claims the benefit of the filing date of U.S. Provisional Application No. 60/746,413, filed May 4, 2006, entitled “METHOD AND SYSTEM FOR ASSESSMENT AND DETERMINING ENVIRONMENTAL RISK FOR PARCELS,” under 35 U.S.C. §119(e).

### FIELD OF THE INVENTION

The field of invention relates generally to real estate transactions and, more specifically but not exclusively relates to techniques for automating the determination of environmental risks for properties and regions.

### BACKGROUND INFORMATION

Environmental assessment is an important consideration for many parties involved in business and real property transactions. For example, environmental assessments should be conducted for transactions such as commercial real estate transactions (buy, sell, lease, finance, refinance, etc.), business transactions (mergers, divestitures, and acquisitions (M&A), and risk underwriting transactions that involve businesses and real property anytime there is a perception of the potential for environmental risk.

The current process for evaluating environmental risk is outlined in the U.S. Environmental Protection Agency (EPA) All Appropriate Inquiries (AAI) (40 CFR Part 312) and ASTM (American Society for Testing and Materials) E-1527 Standard Practice for Phase I Environmental Site Assessment (ESA) Process (most recent version). Phase I ESAs are implemented by environmental consultants using information provided by environmental data vendors and other sources. Environmental consultants gather, analyze, and draw conclusions based on the attributes of a property and the environmental data. The Phase I ESA process is both time and labor intensive and is the current standard for environmental assessments of real property. The ASTM and AAI standards, at their core, help purchasers of properties and the related financing entities evaluate environmental risk and avoid environmental liability under the Comprehensive Environmental Response Compensation and Liability Act (CERCLA).

Phase I ESAs are an inefficient method of characterizing environmental risk because most properties evaluated do not have substantial environmental risks. Accordingly, a great deal of effort is spent on proving the absence of a negative. At present there is a wide gap between raw data provided by environmental data companies and the interpretation of that data of other site-specific environmental issues by environmental consultants, environmental professionals, corporate environmental managers, etc. in the form of Phase I ESAs. Additionally, no efficient system currently exists to easily evaluate CERCLA liability and environmental risk. Accordingly, there is a need for more efficient and effective mechanisms for determining environmental risks.

### SUMMARY OF THE INVENTION

In accordance with aspects of the invention, techniques are disclosed for automating the assessment and determination of environmental risks for properties and regions. Property attribute and characteristic data is aggregated from multiple databases and indexed by a parcel identifier, such as an assessor's parcel number (APN). Environmental data from various databases, such as Federal, State, County, Parrish, Municipality/Town, Tribal, etc. is also retrieved and linked to parcels. An environmental risk assessment score may be calculated based on various attribute, characteristic, and environmental data associated with a given parcel, a parcel and adjacent properties, and/or selected areas or regions. Environmental risk assessment maps may also be generated.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a flowchart illustrating a set of operations used to derive a parcel risk score, according to one embodiment of the invention;

FIG. 2 shows an overview of exemplary data that is fed into an interpretation engine to derive a parcel risk score;

FIG. 3 is a schematic diagram illustrating an overview of exemplary data sources that are accessed to obtain environmental and attribute data and the integration of data from such databases by a parcel APN database and a GIS system, as well as an overall system architecture;

FIGS. 4a and 4b collectively comprise an exemplary set of rules and tabulated data that are used to derive parcel risk scores, according to one embodiment of the invention;

FIG. 5 is a flowchart illustrating operations and logic for determining a parcel risk score in consideration of proximate properties, according to one embodiment of the invention;

FIG. 6 is a flowchart illustrating operations performed by an iterative scheme to calculate parcel risk scores in consideration of parcels within a selected area or region, according to one embodiment of the invention;

FIG. 7 is a diagram illustrating a color-coded risk assessment map, wherein colors are indicative of relative risk levels according to an associated scheme; and

FIG. 8 is a schematic diagram of an exemplary computer server that may be used to implement various aspects of the embodiments described herein.

### DETAILED DESCRIPTION

Embodiments of methods and systems for evaluating environmental risks for businesses and real property are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the present invention, a novel mechanism is provided to efficiently perform environmental assessments and evaluations in a manner that overcomes many of the inefficiencies and associated monetary and time-costs under the current techniques discussed above. The mechanism employs real property information delineated by parcel to retrieve raw environmental data and property attributes. A rules-based interpretation engine and associated scoring system is then used to automatically generate a risk assessment score and/or alert.

Under one implementation of the invention, referred to herein as the Parcel Insight (PI) system, environmental data and parcel characteristics are aggregated and interpreted to identify environmental vulnerabilities and risk. Environmental data is currently provided (typically) using address range street maps. Existing environmental data vendors do not interpret environmental data to identify the likelihood that a property is subject to CERCLA liability and non-CERCLA environmental liabilities and the data they provide does not evaluate environmental considerations at the parcel level. Manual interpretation of the environmental data and the assignment of that data to specific parcels or regions by environmental professionals is required to evaluate and understand the environmental data and characterize the potential environmental risk.

The subject real property or parcel is the base unit in the Parcel Insight system. Information that is used to generate a score is tied to the parcel, either directly, or indirectly. In order to accomplish this task, various database and search mechanisms are employed to link a parcel with it corresponding input data. Some characteristics, such as legal property characteristics, are already tied to the parcel in most jurisdictions. Government environmental databases, which are organized by address and latitude/longitude, are converted to parcel-specific information.

The Parcel Insight system draws together geographic information systems (GIS) and a rule-based system to interpret environmental conditions that relate to a specific parcel. The rule-based system converts what is now a labor and time intensive practice of evaluating the parcel specific environmental risk to a computer generated score that is nearly instantaneous in an automated manner.

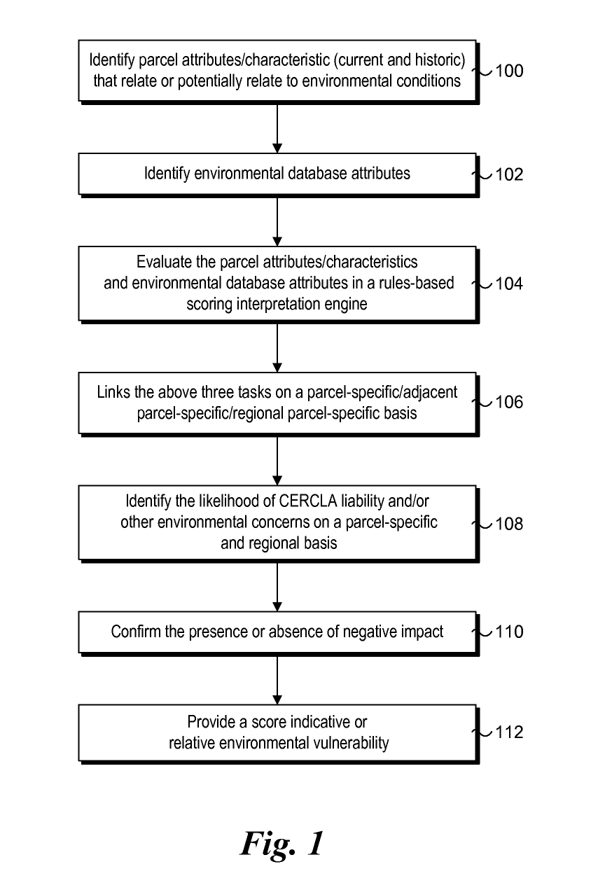

FIG. 1 shows a flowchart illustrating an exemplary set of operations performed by one embodiment of the Parcel Insight system to produce a score indicative of relative environmental vulnerability for a given parcel. The process begins in a block 100, wherein parcel attributes/characteristics (current and historic) that relate or potentially relate to environmental conditions are identified. In a block 102, environmental database attributes are also identified. The parcel attributes/characteristics and environmental database attributes are then evaluated using a rules-based scoring interpretation engine, as depicted in a block 104.

In a block 106, the foregoing tasks are linked on a parcel-specific/adjacent parcel-specific/regional parcel-specific basis. The likelihood of CERCLA liability and/or other environmental concerns are then identified on a parcel-specific and regional basis in a block 108. In a block 110, the presence or absence of negative impact is confirmed. The process is completed in a block 112, which provides a score indicative of relative environmental vulnerability for the parcel.

As discussed above, one of the inputs to the PI system is property attribute and characteristic data pertinent to a given parcel and proximate properties. In one embodiment, the attributes and characteristics used by the Parcel Insight system may include but are not limited to:
a. Property attributes tied to parcels that include:
   i. current use of property
   ii. age of construction
   iii. size of building(s) and parcel
   iv. availability of and connection to public water and sewer
   v. water withdrawal/monitoring systems
   vi. presence of asbestos
   vii. zoning
   viii. size of the building(s)
   ix. presence or absence of underground parking
   x. construction materials
   xi. heating system and fuel for heating system
   xii. wind direction
   xiii. dates of recent transactions
   xiv. names of current and past owners/occupants/uses
   xv. dates of and names of entities involved in recent financings
   xvi. site-specific SIC or NAICS codes
   xvii. institutional controls/activity use limitations/deed restrictions/environmental cleanup liens/easement/government no further action letters/covenants not to sue
   xviii. availability of Fire Insurance Maps
   xix. topologic and hydrogeologic conditions
   xx. specialized knowledge
   xxi. fair market value of the parcel
   xxii. commonly known information
   xxiii. identification of current and former owners and occupants
   xxiv. seismic hazards
   xxv. wetlands
   xxvi. geologically unstable locations
   xxvii. steeply sloped parcels
   xxviii. endangered species habitat
   xxix. archaeological resources
   xxx. sensitive habitats
   xxxi. user-provided information
   xxxii. the existence of prior Phase I ESAs
b. The neighborhood/regional attributes/characteristics
c. Federal, state, tribal, and local government environmental databases addressing current and former:
   i. use, storage, releases, and removal of hazardous materials (including petroleum)
   ii. releases of hazardous materials (including petroleum)
   iii. cleanup and closure of hazardous materials releases (including petroleum)
   iv. regulatory agency involvement and no further action determination by regulatory authorities
   v. natural resource damages
   vi. parties responsible for releases
   vii. source of hazardous material (including petroleum) release
   viii. additional local/state/tribal/federal databases identified in ASTM E1527 and 40 CFR Part 312
d. The degree of obviousness of contamination based on the totality of the information reviewed.

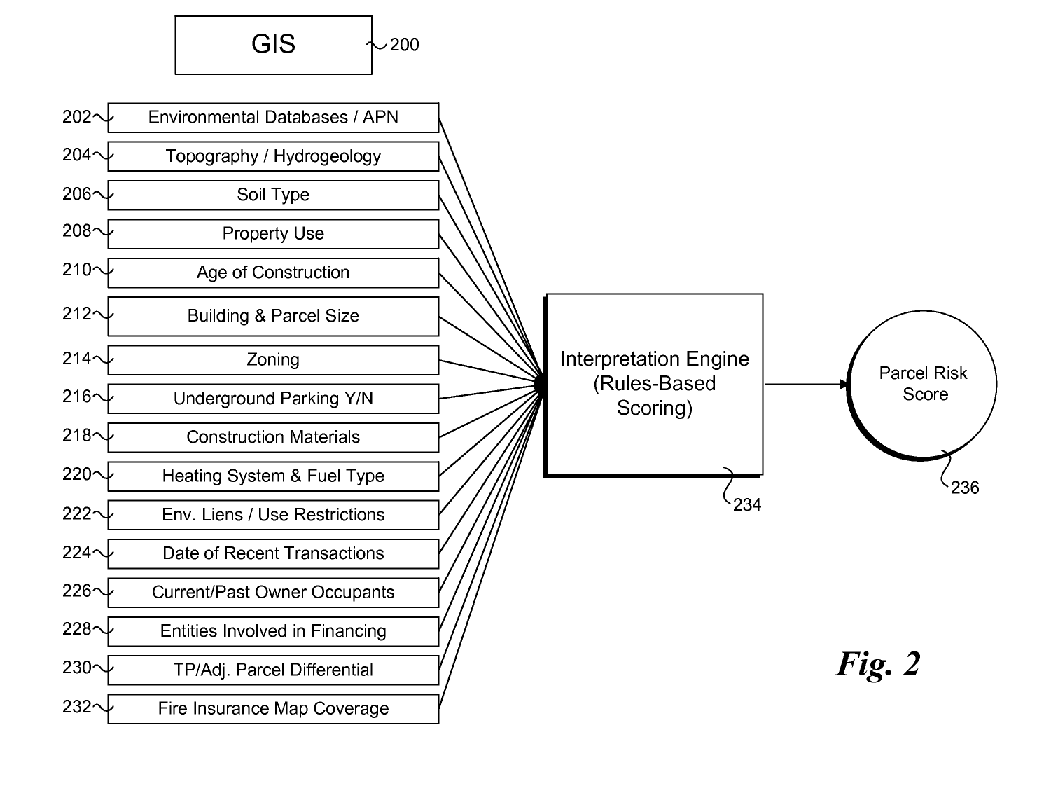

FIG. 2 shows a schematic overview of the process with selected parcel attributes/characteristics and database inputs. The illustrated input includes GIS 200, via which various attribute, characteristic, and environmental data may be stored and linked. This data is illustrated by way of exemplary data, including Environmental Databases/APN (Assessor's Parcel Number) 202, Topology/Hydrogeology 204, Soil Type 206, Property Use 208, Age of Construction 210, Building and Parcel Size 212, Zoning 214, Underground Parking 216, Construction Materials 218, Heating System & Fuel Type 220, Environmental Liens/Use Restrictions 222, Data of Recent Transactions 224, Current/Past Owner Occupants 226, Entities involved in Financing 228, Target/Subject Property (TP)/Adjacent Parcel Differential 230, and Fire Insurance Map Coverage 232. Various data stored in GIS 200 and possibly other databases (not shown in FIG. 2) are fed into a rules-based interpretation engine 234, which processes the information and outputs a parcel score 236 indicative of a relative environmental risk for the parcel.

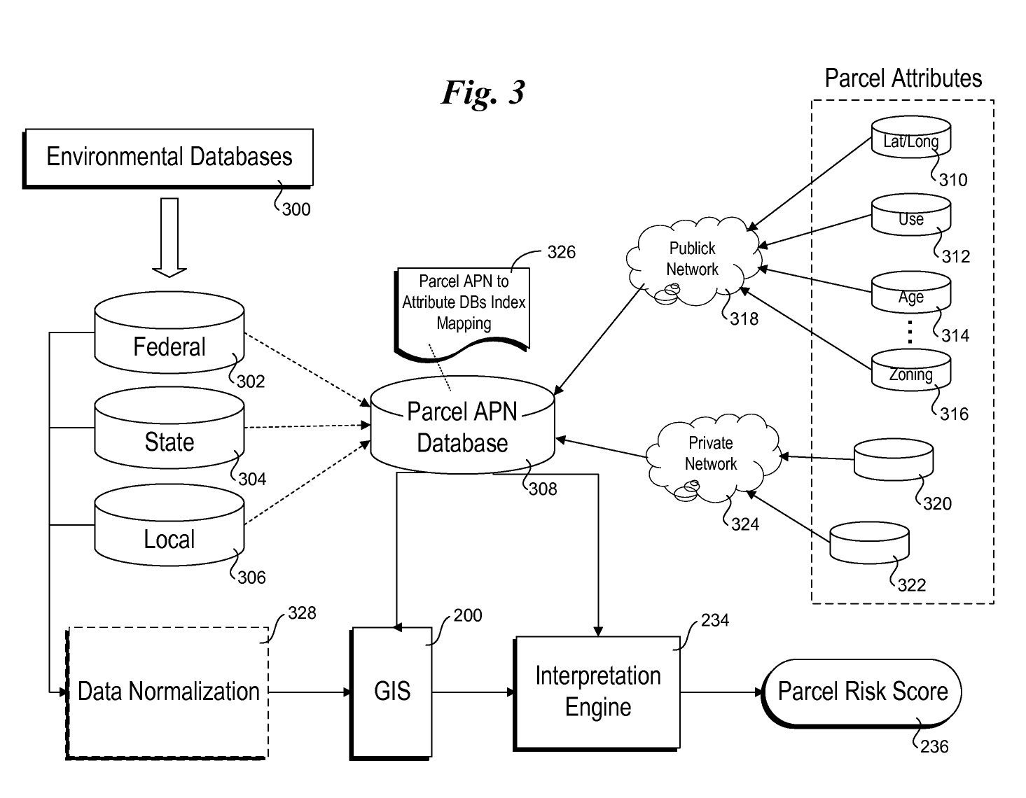

FIG. 3 shows an overview of data gathering and processing operations, according to one embodiment. As discussed above, various data identifying various attributes, characteristics and environmental data associated with parcels (directly or indirectly) are used as inputs to interpretation engine 234. Originally, these data are stored in (generally) disparate databases that store a particular type of information based on operations associated with the public or private entity maintaining the data. These data stores are schematically depicted as including environmental databases 300 comprising federal database 302, state database 304, and local database 306. It is noted that these databases are merely illustrative of environmental databases maintained by government entities as various levels, including federal, state, county or parish, district (e.g., water district), municipality, etc.

At the center of the system is a parcel database APN 308. The database is used to store parcel attribute and characteristic data that are aggregated from data generally stored in a combination of public and private databases and/or providing mapping information to enable aggregation of data relating to a given parcel using a common parcel identifier. Exemplary public databases depicted in FIG. 3 by selected databases, including latitude/longitude database 310, use database 312, age database 314, and zoning database 316, which are accessed via a public network 318, such as, the Internet and potential other public networks. Exemplary private databases 320 and 322, which might typically be managed by non-public entities (but may possibly include databases managed by public entities as well), are accessed via a private network 324. It will be understood that private network 324 is illustrative of a communication path that is not generally accessible to the public; however, the network infrastructure itself may be public, private, or a combination of the two. For example, a virtual private network (VPN) connection is illustrated by way of private network 324. By further way of example, a public entity may provide access to a database containing data that may be employed for parcel attribute purposes to a subscriber, while that same information may or may not be (readily) available to the general public.

In general, the data stored in the various databases illustrated in FIG. 3, as well as other databases (not shown), will be stored in a manner under which they can be accessed via some type of identifier (i.e., index). For parcels themselves, this information will be indexed via an assessor's parcel number or the like. For some other types of information, the address of the property will be used as the identifier. For still other types of information, a larger granularity may be employed, such as a block, a section, a zip code, a municipality, a country, a district, a region, etc.

As termed herein, information that is identified by parcel (e.g., by APN, in a given database) is directly linked to a parcel. This will usually be the case for information such as parcel description and parcel tax records, which are typically stored by city, county, or parish depending on the locality. Meanwhile, information that is identified by some other identifier is termed as being indirectly linked to a parcel. Accordingly, there needs to be some mechanism for linking parcels to this information. This linking information is maintained by parcel database 308 as APN to database index mapping information 326. Thus, parcel APN database 308 indexes data by APN using various mapping tables and the like to enable a requester to access various attributes and characteristics of selected parcels by simply providing the APN(s) for those selected parcels. Moreover, this information may be accessed via a “one stop shop,” without requiring the data to be manually searched or otherwise acquired in a separate manner.

As describe above, APN database 308 may store aggregated data and/or mapping data to enable data to be aggregated from various external databases “on the fly.” In one embodiment, data is periodically downloaded from one or more of these databases, aggregated in APN database 308 (or GIS 200, as described below), and re-indexed based on parcel APN. While this scheme necessitates more storage requirements, it covers situations where external databases may not be immediately available (e.g., they could be taken offline for maintenance, inaccessible due to network problems at the host site, etc.). In some cases, the data in an external database may be of such volume that it is not advantageous to store another instance of the data locally (i.e., in APN database 308 or GIS 200). Thus, this data is retrieved from such a database on an as-needed basis, using applicable mapping information (for cases in which the database index is not based on parcel APN).

Typically, the mapping information enables the external database to be queried using its own indexing scheme, where the applicable index value is derived from the mapping information in view of one or more selected parcel APNs. For example, if a database stored information based on county, mapping information that mapped APNs to counties would be used to identify the applicable county for a parcel for which data is sought, and the query would request to access the data associated with the applicable county.

Similarly, the environmental data in environmental databases 300 may be indexed in one of various ways. For example, some databases may store information based on an address or by longitude and latitude. Other databases may store information based on it own internal grid system. As with the parcel attribute/characteristic databases, one aspect of the PI system is to link data by parcel. With respect to the environmental databases 300 (and, potentially as well as some of the parcel attribute/characteristic databases), there are two ways for linking information by parcel. One scheme is to use mapping information in parcel APN database 308 to map the environmental data so that it can be indexed by parcel APN. Another scheme is to have this “mapping” be performed by GIS 200. As yet another option, a portion of the mapping may be performed by parcel APN database 308, while another portion may be performed by GIS 200.

In some instances, it may be advantageous to normalize the environmental data before it is stored in GIS 200. Accordingly, such data normalization operations are schematically depicted by a data normalization block 328.

In some embodiments, aggregation of data into analytic information is performed, at least in part, by Geographic Information System 200. In general, GIS is a computer technology that uses a geographic information system as an analytic framework for managing and integrating data; solving a problem; or understanding a past, present, or future situation. With a GIS, you can link information (attributes) to location data, such as people to addresses, buildings to parcels, or streets within a network. You can then layer that information to give you a better understanding of how it all works together. You choose what layers to combine based on what questions you need to answer. Such layering may be interactively selected, or programmatically selected via associating modeling tools and the like.

A GIS is usually associated with maps. A map, however, is only one way you can work with geographic data in a GIS, and only one type of product generated by a GIS. In general, A GIS can be viewed in three ways: the database view, a map view, and a model view.

With respect to the database view, A GIS is a unique kind of database, commonly referred to as a geodatabase—a geographic database of an area, region, country, etc. Fundamentally, a GIS is based on a structured database that describes the information (e.g., features, attributes, etc.) in geographic terms. As part of a GIS geodatabase design, users specify how certain features will be represented. For example, parcels may typically be represented as polygons, streets may be mapped as centerlines, specific features as points, and so on. These features are collected into feature classes in which each collection has a common geographic representation.

In addition to geographic representations, GIS data sets include traditional tabular attributes that describe the geographic objects. Many tables can be linked to the geographic objects by one field or a set of fields comprising a “key”. These tabular information sets and relationships play a key role in GIS data models, just as they do in traditional database applications.

GIS organizes geographic data into a series of thematic layers and tables. Since geographic data sets in a GIS are geo-referenced, they have real-world locations and overlay one another (i.e., are spatially related). In a GIS, collections of geographic objects and/or attribute data are organized into layers such as parcels, buildings, geographical boundary definitions (e.g., boundaries defining aggregated areas, such as blocks, cities, counties, regions, etc.) Many of the spatial relationships between layers can be derived through their common geographic location (using an underlying location reference scheme).

The map view corresponds to the view one typically thinks of for geographic data. For example, a parcel map includes the geographical boundaries for various parcels covered by the map. There are many other types of maps used in a GIS to define associated data, such as zoning maps, city maps, geological feature maps, water district maps, topologic maps, wetland maps, and seismic maps, just to name a few. In a GIS, the physical information (e.g., boundary definitions, feature and attribute data, etc.) needs to be mapped into corresponding data comprising data tables and objects. As discussed above, these mapping views are layered on top of one another via internal GIS operations such that all of the applicable layer data for a given point can be queried. This will usually be done through whatever location reference scheme is employed, such as using an absolute location system (e.g., grid system, longitude/latitude system, global positioning system coordinates, etc.) employing geographical boundaries. Accordingly, all boundaries corresponding to the given layers are mapped to the same underlying location reference scheme.

GIS maps are similar to static, printed maps, except that you can interact with them. In some GIS implementations, users can pan and zoom an interactive map in which map layers turn on and off at appropriate map scales. Users can also apply symbols for a map layer based on any set of attributes. For example, parcels can be shaded with colors based on their zoning types or to specify a particular attribute type, such as a wetland, environmental restricted area, etc.

The model view pertains to modeling tools and capabilities used to derive new data from existing data. A GIS may include a set of information transformation tools that derive new geographic datasets from existing datasets. These geo-processing functions take information from existing datasets, apply analytic functions, and write results into new derived datasets. By combining data and applying some analytic rules, users can create models of data they would like to analyze.

In view of the expanded availability of geographical information systems, a wide range of data maintained by government agencies (federal, state, county, municipality) is stored in a manner that can be easily input to a GIS. For example, GIS are typically configured to read in and process raster data, such as provided by a satellite photograph or aerial photography, and vector data, which is used to define geographical features using lines, points, arcs, and other geometrical data. Both of these types of data are processed by the GIS to a common location reference scheme used by the system, enabling the data to be spatially related and for facilitating modeling and analytic functions.

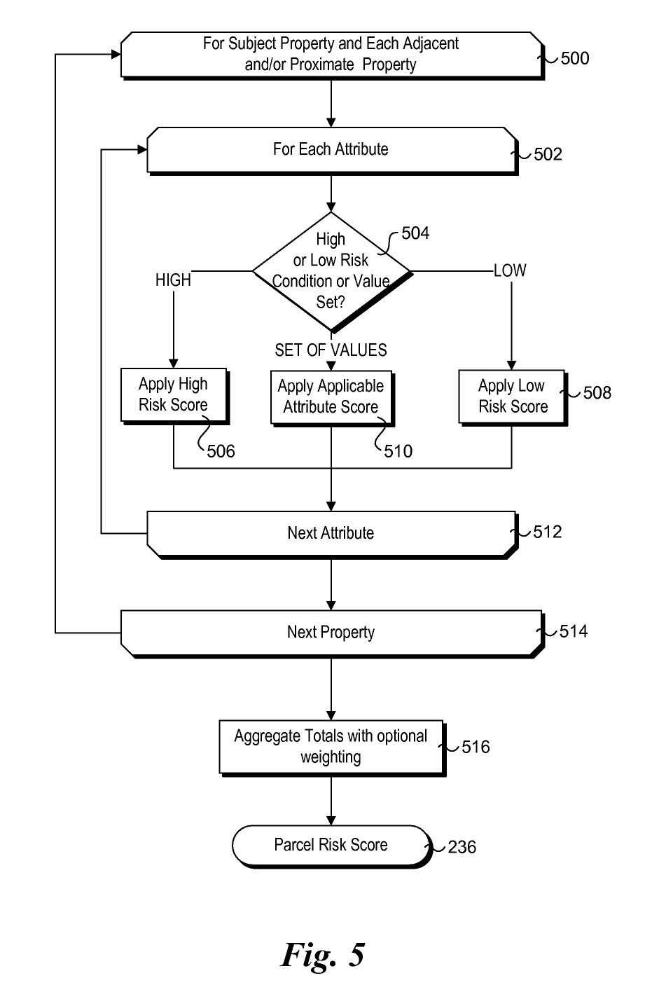

Returning to FIG. 3, inputs from GIS 200 and/or parcel database APN 308 are fed into interpretation engine 234 and processed to produce a parcel risk score 236. In general, the interpretation engine is programmed with a set of rules and associated scores for each of multiple attributes that are associated either directly or indirectly with a selected parcel. In one embodiment, such as illustrated in FIG. 5, there is a rule for each attribute that determines if the attribute value corresponds to a high risk or a low risk (with respect to environmental risk). A corresponding score pertaining to the risk (high or low) is then applied to the attribute. The attribute scores are then aggregated to produce a total score.

In accordance with further aspects of the embodiment of FIG. 5, this attribute score assessment and aggregation is applied to not only the subject property, but also to one or more adjacent or proximate properties as well. The attribute scores for the various properties are then aggregated to produce a total score for the subject property. As discussed below, various weighting factors may be applied to the adjacent/proximate properties to tune the scoring.

In general, the interpretation engine may be implemented as a separate module or process (as depicted in FIGS. 2 and 3), or may be programmed into GIS 200 as a risk assessment model. Moreover, the data and rules may be programmed in an embedded application, or may be implemented under an interactive programming module that is readily changeable by users, including users with little or no programming experience. In addition, various display schemes may be used to present the risk assessment output, such as via a tabulated view, a color-coded graphical view, etc.

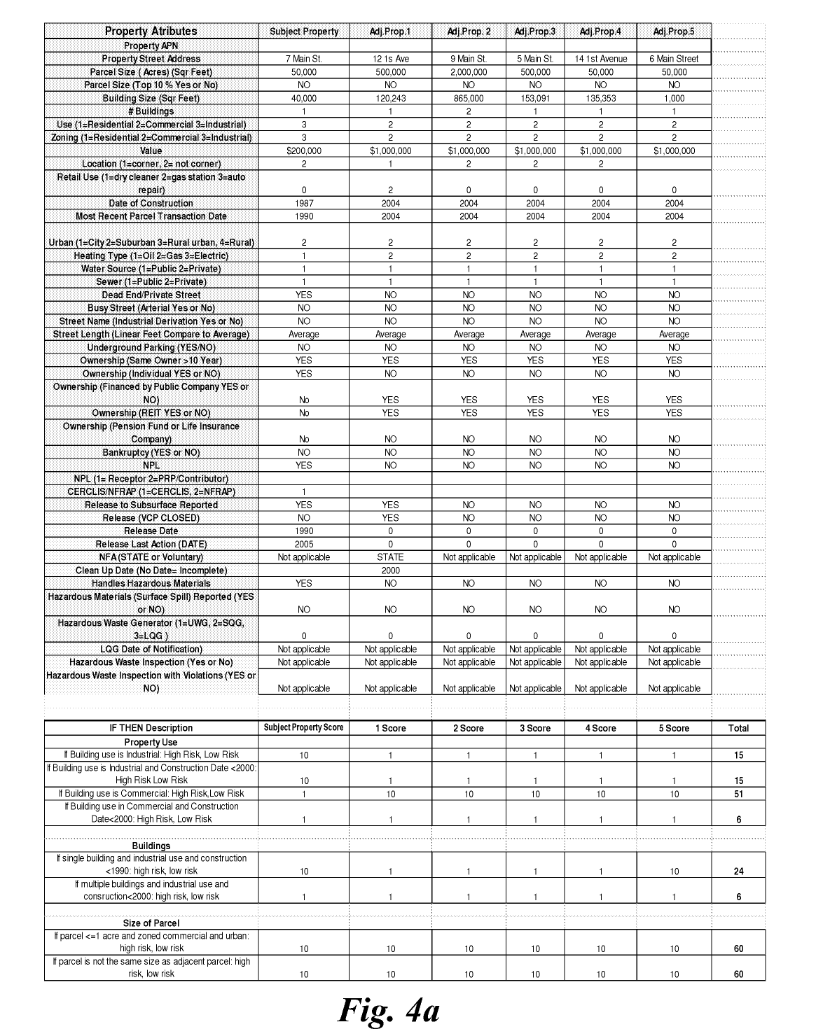

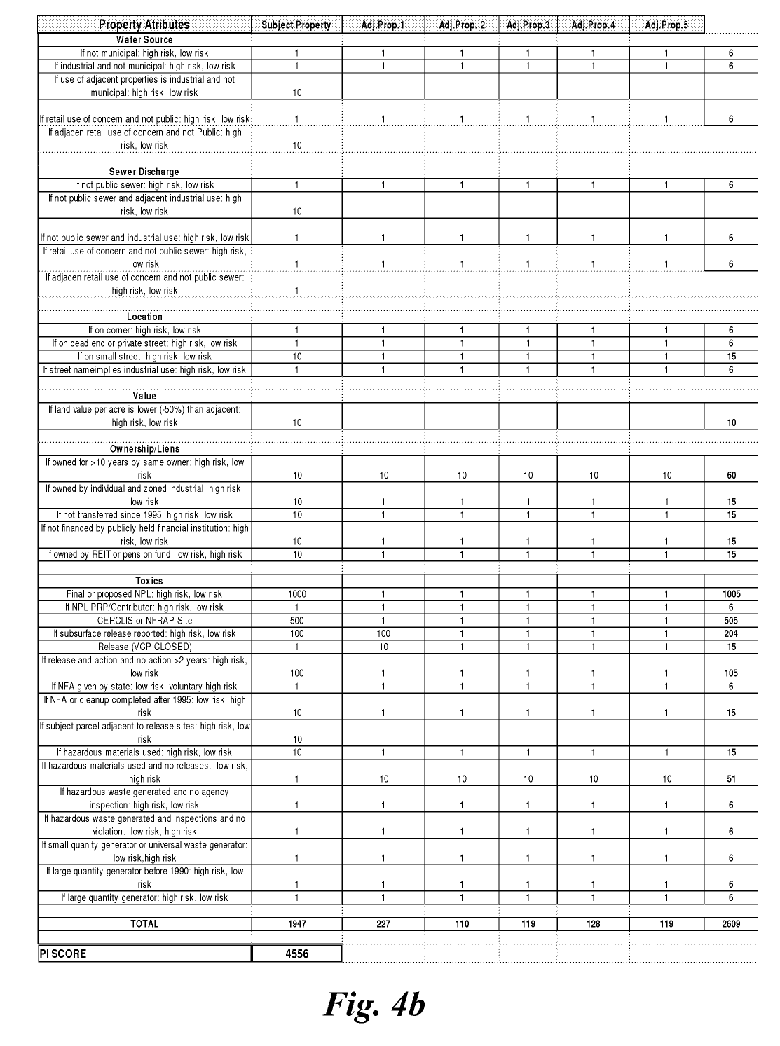

The tabulated view shown in FIGS. 4a and 4b is illustrative of a set of exemplary attributes and exemplary rules corresponding to a given risk assessment process for a subject property that also considers attributes of five adjacent properties. It is noted that the number of adjacent properties is merely illustrative, as various numbers of adjacent properties may be considered. Furthermore, as described below, an iterative process may be applied over a larger number of parcels for a proximate region (or even much larger regions) to obtain parcel risk scores for all of the parcels within a region. Under this approach, a large number of parcels are effectively considered in determining a parcel risk score for a given parcel. In addition to containing rules and scores, a tabulated view may also list various property attributes that may not be employed in the scoring determination, but rather are provided for informative purposes, such as address information, property value, ownership attributes, etc.

In general, various types of rules may be used for each attribute assessment. These may include, but are not limited to attribute value rules and conditional rules. The upper portion of the property attributes on FIG. 4a includes some attribute value rules, wherein a given attribute is assigned an associated value on a one-to-one basis. For instance, the Urban property attribute contains a set of potential values: 1=City, 2=Suburban, 3=Rural Urban, 4=Rural. Meanwhile, the conditional rules are typically in the form of,

```
If attribute condition is true,
    then apply a first value;
else (if the condition is false),
    apply a second value:
```

In the context of the present example, these true and false outcomes are associated with high and low risk indicators (a true outcome may be associated with one of a high or low risk indicator, depending on the particular condition being assessed), each having an associated score.

With reference to FIGS. 4a, 4b, and 5, a parcel risk assessment process in accordance with one embodiment proceeds as follows. First, a subject property is selected, along with the adjacent and/or proximate properties that are to be used in the assessment. As depicted by outer start and end loop blocks 500 and 514, the set of operations depicted in the inner loop of FIG. 5 are performed for each of these properties. As depicted by inner start and end loop blocks 502 and 512, the operations and logic therein is applied to each attribute being assessed. In a decision block 504 a determination is made to whether the condition or rule being evaluated results in a high risk, a low risk, or an attribute value in a set of values. If a conditional attribute is associated with a high risk condition, an associated high risk score (for the respective attribute) is applied in a block 506. Similarly, if a conditional attribute is associated with a low risk condition, an associated low risk score is applied in a block 508. Meanwhile, if the rule applies to a set of attribute values, the applicable attribute value (score) is applied in a block 510.

After each of the applicable attributes has been evaluated for each of the properties, and aggregate total with optional weighting parameters is determined in a block 516. For example, a weighting parameter may be applied based on a given parameter, such a proximity to the subject parcel. Under this approach, the risk score for a property directly adjacent to the subject property may be assigned a higher weight than a property further away. The output of block 516 is the parcel risk score 236 for the subject property.

An exemplary set of attributes associated with If . . . then conditional rules is shown in FIGS. 4a and 4b. These are categorized by an associated attribute category, including Property Use, Buildings, Size of Parcel, Water Source, Sewer Discharge, Location, Value, Ownership/Liens, and Toxics. It is noted that this is merely an exemplary set of categories, as other categories and associated rules may also be added in addition to or in place of the illustrated conditional rules.

The relative weighting (i.e., score) for each conditional or attribute value set will typically be defined by the interpretation engine developer (developer). However, an optional interface may be provided to enable a user (or developer) to adjust the scores and values of an existing implementation.

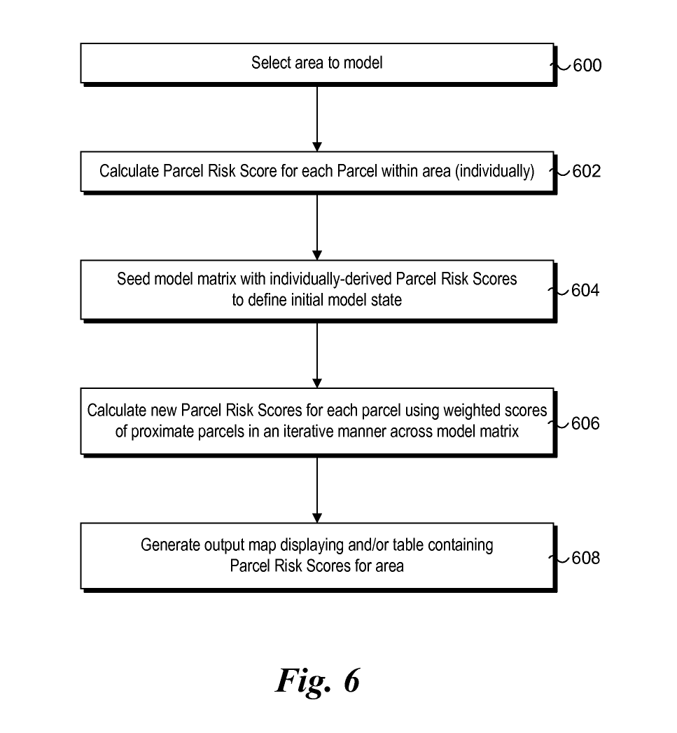

According to an aspect of some embodiments, a parcel risk score that (effectively) reflects input from a number of proximate parcels may be calculated by either interpretation engine 234 or GIS 200, depending on the particular implementation. Operations corresponding to one embodiment of such a process are depicted in the flowchart of FIG. 6. The process begins by selecting an area to be modeled in a block 600. The area may correspond to a defined region (e.g., block, municipality, county, etc.), or may be selected by using a selection box or the like on a map displayed by GIS 200. In essence, the area selected in block 600 defines the parcels that are to be evaluated for risk assessment.

Next, in a block 602, a parcel risk score is calculated for each parcel within the area on an individual basis (i.e., without consideration of other proximate parcels.). These calculations are used to seed a model matrix with initial parcel risk score values, as depicted in a block 604.

In a block 606, new parcel risk scores are then calculated for each parcel using weighted scores of proximate parcels in an iterative manner across the model matrix. This operation is similar to finite element modeling, where an iteration begins at one corner (or applicable starting point) of the model matrix, and proceeds across the model matrix in an ordered manner, with the updated parcel risk scores just calculated during a given iteration used as inputs to the calculation of a current parcel. The iteration across the model matrix will generally be repeated until a predetermined or selectable level of convergence is reached for the parcel scores. Such iterative modeling techniques are well-known in the art. For example, a Runge-Kutta modeling scheme may be used in one embodiment. Other linear and non-linear modeling schemes may also be used. In general, the model matrix may be defined as a point mesh (e.g., parcel geographical centroids may be used as the location for the points in the model mesh), may employ finite elements (e.g., the elements may have a fixed shape or may have boundaries defined by a parcel itself), or a combination of the two. Other modeling techniques known to those skilled in the art may be used as well.

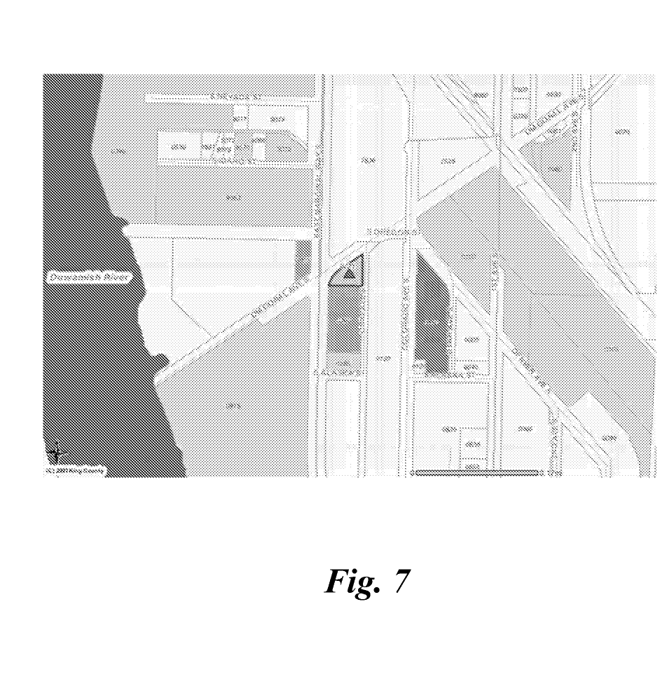

The output of the operations of block 606 may be fed into GIS 200 or another separate front-end to be viewed by a user. For example, as depicted in block 608, an output map graphically displaying the parcel risk scores (or relative indication thereof) and/or tabulated data containing the parcel risk scores may be generated. In one embodiment, the parcel risk map is color-coded to readily identify the level of risk for the various parcels in the area, such as depicted in FIG. 7. Interpolation may be used, as appropriate, to smooth the graphical data. Similarly, tabulated information may be presented for a selected parcel, or group of parcels, enabling the user to not only see a total score, but to also readily view the components of the score.

Once the parcel risk scores are calculated, there are various other views that may be depicted by GIS 200, including views that may be interactively selected via component parts of the underlying data. For example, a user may select to display environment risk scores pertaining to a single category (e.g., toxics), or multiple selectable categories, (e.g., water source plus sewer discharge plus wetlands). By presenting data in this manner, future risks assessments might be made in consideration of factors that are likely or predicted to have more emphasis in the future. Such interactive selection and modeling capabilities may be facilitated by GIS 200, a separate application or system, or a combination of the two.

The Parcel Insight information drives a risk score, recommendations, and cost estimates that can be factored into the valuation of a property or business or drive more focused due diligence. The Parcel Insight information provides an improved assurance of the absence of a negative impact, when compared with conventional approaches.

In general, the information generated by the Parcel Insight system may be used for a variety of purposes, including but not limited to:
1. facilitate real estate transactions, mergers, divestitures, acquisitions, leasing, and financing involving real property and ongoing operations;
2. facilitate the underwriting of insurance, both title and commercial policies, that include or exclude environmental coverage;
3. compare and rank parcels based on, at least in part, environmental risk;
4. evaluate environmental reserves/cost contingencies;
5. evaluate all varieties of property types and uses;
6. evaluate third-party liabilities;
7. facilitate financing evaluations;
8. evaluate the relative exposure of a region with respect to environmental considerations;
9. expand credit scoring systems to factor in environmental conditions;
10. facilitate commercial mortgage backed securities (CMBS) underwriting;
11. facilitate rating agency underwriting and decision-making; and
12. facilitate lenders, consultant, occupant/developer, appraisal evaluations.

As discussed above, various aspects of the PI system and overall processing techniques are implemented via computer-based systems running associated software. For example, parcel APN database 308 may be implemented on a computer server, server farm, modular blade server environment, or similar server environments.

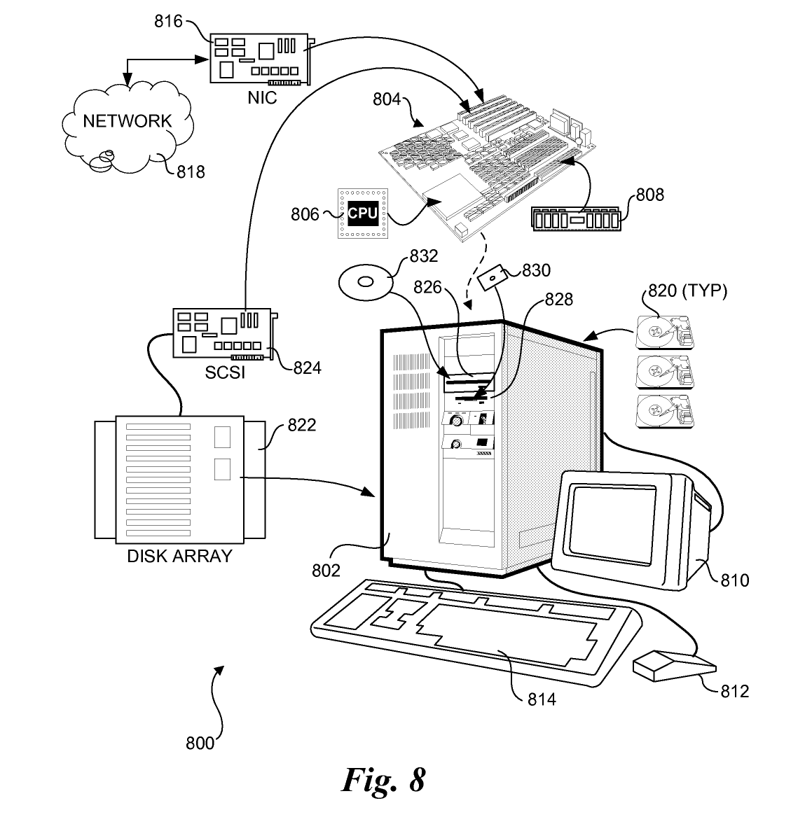

One such exemplary computer server 800 is shown in FIG. 8. In general, computer server 800 may be used for running various application server software modules and components, such as commercial databases and commercial and specifically-developed applications, modules, and the like. Although depicted as a single server, it may be advantageous to implement a multi-tiered architecture using well-known server architecture schemes. Examples of computer systems that may be suitable for these purposes include stand-alone and enterprise-class servers operating UNIX-based and LINUX-based operating systems, as well as servers running the Windows 2000 or Windows 2003 Server operating systems. Other types of operating systems and computer/server platforms may be used as well. Moreover, distributed computing architectures may also be used.

Computer server 800 includes a chassis 802 in which is mounted a motherboard 804 populated with appropriate integrated circuits, including one or more processors 806 and memory (e.g., DIMMs or SIMMs) 808, as is generally well known to those of ordinary skill in the art. A monitor 810 is included for displaying graphics and text generated by software programs and program modules that are run by the computer server. A mouse 812 (or other pointing device) may be connected to a serial port (or to a bus port or USB port) on the rear of chassis 802, and signals from mouse 812 are conveyed to the motherboard to control a cursor on the display and to select text, menu options, and graphic components displayed on monitor 810 by software programs and modules executing on the computer. In addition, a keyboard 814 is coupled to the motherboard for user entry of text and commands that affect the running of software programs executing on the computer. Computer server 800 also includes a network interface card (NIC) 816, or equivalent circuitry built into the motherboard to enable the server to send and receive data via a network 818.

File system storage corresponding may typically be implemented via a plurality of hard disks 820 that are stored internally within chassis 802, and/or via a plurality of hard disks that are stored in an external disk array 822 that may be accessed via a SCSI card 824 or equivalent SCSI circuitry built into the motherboard. Other types of disk drive interfaces may be used, including serial ATA interfaces and the like. Optionally, disk array 822 may be accessed using a Fibre Channel link using an appropriate Fibre Channel interface card (not shown) or built-in circuitry. Moreover, other types of mass storage schemes may be employed, including remote storage schemes such as storage attached networks and network-attached storage appliances.

Computer server 800 generally may include a compact disk-read only memory (CD-ROM) drive 826 into which a CD-ROM disk may be inserted so that executable files and data on the disk can be read for transfer into memory 808 and/or into storage on hard disk 820. Similarly, a floppy drive 828 may be provided for such purposes. Other mass memory storage devices such as an optical recorded medium or DVD drive may also be included. The machine instructions comprising the software components that cause processor(s) 806 to implement the operations of the present invention that have been discussed above will typically be distributed on floppy disks 830 or CD-ROMs 832 (or other memory media) and stored in one or more hard disks 820 until loaded into memory 808 for execution by processor(s) 806. Optionally, the machine instructions may be loaded via network 818 as a carrier wave file.

Thus, embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

In general, parcel APN database 308 may be implemented using one of several commercially available database “backends” in conjunction with commercial and/or specifically developed software application and modules, which may implemented for front-end and/or middleware tiers. Exemplary relational databases that may be used include SQL databases, such as those offered by Oracle, Microsoft (SQL Server), IBM (DB2), Sybase, MySQL, and others. Additionally, communications applications for accessing remote databases may be implemented using well-known applications employed in Unix, Linux, and Windows environments.

Although depicted as a single database for illustrative purposes, the functionality discussed herein for APN database may be implemented by one or more “aggregated” databases. Moreover, each of such databases may perform specific data aggregations (e.g., store and aggregate specific types of attribute and characteristic data) and/or store data pertaining to a particular region or regions.

GIS 200 may be hosted by one of several commercially available GIS systems and/or associated applications, including but not limited to systems and applications from ESRI, Redlands, Calif. (e.g., ArcGIS integrated products); Intergraph Corporation, Madison, Ala. (e.g., Geomedia Parcel Manager and Geomedia Fusion); MapInfo Corporation, Troy, N.Y.; HDM (Harvard Design and Mapping), Cambridge, Mass.; and SAS Institute Inc., Cary, N.C.

Generally, a PI system implementation may support private and/or public access. For example, in one embodiment the PI system includes a Web-based “front-end” that enables users to receive various environmental risk-assessment data. For instance, such information may be available using a subscription service employing well-known user authentication techniques (e.g., userID and password), a fee-per-use service, and/or free services. Moreover, a Web portal may be deployed to facilitate access to mapping data generated by the PI system that may be used in conjunction with other mapping data as an overlay layer or the like. This may be used to enable popular Web services such as GOOGLE™ Maps, ZILLOW™, MAPQUEST™, etc. to add environmental risk assessment mapping data to their existing maps, thereby enhancing the user experience in increasing Web traffic. Depending on the particular user or purpose, such maps may comprise scalable vector-based data and/or raster-based data.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for automating assessment of environmental risk of a parcel, comprising:
automatically retrieving property attribute and characteristic data associated with a parcel from multiple databases;
automatically retrieving environmental data associated with the parcel from multiple environmental databases; and
automatically calculating an environmental risk assessment score based on the parcel attribute and characteristic data and the environmental data.

2. The method of claim 1, further comprising
aggregating property attribute and characteristic data from at least a portion of said multiple databases into an aggregated database;
indexing the aggregated property attribute and characteristic data in the aggregated database by a parcel identifier; and
employing the parcel identifier to retrieve at least a portion of the property attribute and characteristic data associated with the parcel from the aggregated database.

3. The method of claim 1, further comprising:
aggregating environmental data from at least a portion of said multiple databases into an aggregated database;
indexing the aggregated environmental data in the aggregated database by a parcel identifier; and
employing the parcel identifier to retrieve at least a portion of the environmental data associated with the parcel from the aggregated database.

4. The method of claim 1, further comprising:
generating mapping information to map data applicable to parcels stored in at least one property attribute, characteristic and/or environmental database that is indexed in its database using an index different than the parcel identifier in a manner that enables such data to be accessed via the parcel identifier; and
employing the mapping information to retrieve information associated with a given parcel from said at least one property attribute, characteristic and/or environmental database.

5. The method of claim 4, further comprising:
employing a Geographic Information System (GIS) to generate at least a portion of the mapping information.

6. The method of claim 1, further comprising:
processing the property attribute and characteristic data and environmental data using a rules-based scoring engine to generate a relative environmental risk assessment score.

7. The method of claim 6, further comprising:
defining a plurality of rules to be implemented by the rules-based scoring engine.

8. The method of claim 7, wherein the rules include conditional rules.

9. The method of claim 7, wherein the rules include attribute value rules.

10. The method of claim 1, further comprising:
employing weighted environmental risk assessment scores for parcels proximate to a selected parcel to calculate a risk assessment score for the selected parcel.

11. The method of claim 10, further comprising:
determining environmental risk assessment scores for a plurality of parcels; and
generating an environmental risk assessment map using the environmental risk assessment scores.

12. The method of claim 1, further comprising:
employing an iterative process to generate risk assessment scores for a plurality of parcels within a selected area,
wherein the environmental risk assessment score for a given parcel is at least partially a function of environmental risk assessment scores of parcels proximate to the given parcel.
